(19) United States
(12) Patent Application Publication
(10) Pub. No.: US 2026/0341096 A1
(43) Pub. Date: Oct. 29, 2026

(54) Vending Machine with Controlled Dispense Limits

(71) Applicants: Stanislav Konrath, Milwaukee, WI (US); Christopher Trudeau, Milwaukee, WI (US); Robert Deiss, Milwaukee, WI (US)

(72) Inventors: Stanislav Konrath, Milwaukee, WI (US); Christopher Trudeau, Milwaukee, WI (US); Robert Deiss, Milwaukee, WI (US)

(21) Appl. No.: 19/656,601

(22) Filed: Apr. 23, 2026

Related U.S. Application Data
(60) Provisional application No. 63/793,386, filed on Apr. 23, 2025.

(51) Int. Cl. G07F 17/00

(52) U.S. Cl. CPC G07F 17/0035

(57) ABSTRACT

A vending machine for in-pack chance promotion game pieces or other items has a housing with a compartment for retaining items. A controller is mounted to the housing and connected to a remote computer operated by a supplier of the items. An authorizing code is loaded on the vending machine which accords to a set number of authorized dispenses which is confirmed with a database on the remote computer. The controller controls an actuator to selectively release items to purchasers who provide payment through a payment interface. When payment is received, the controller determines whether the number requested to be dispensed is authorized and operates the actuator to dispense the items. If the dispenser is not licensed to dispense the full amount, the actuator dispenses items up to the licensed number and refunds to the purchaser any payment made beyond that due for the dispensed items.

### CROSS REFERENCES TO RELATED APPLICATIONS

This application claims the benefit of priority of U.S. provisional App. No. 63/793,386 filed Apr. 23, 2025, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to vending machines in general, and more particularly to vending machines which are controlled to dispense only authorized products.

Items that are sold directly to consumers can be efficiently offered to retail customers through mechanized dispensers or vending machines. For example, location-specific games of chance employ game pieces which are sold and redeemed on site. Games of chance can be, among other games, in-pack chance promotions, sweepstakes, or lottery-like in nature. Generally, game pieces are sold to operators of locations in packs, usually of around 4,000 pieces. In these games there is a predetermined prize structure, number of winners, and chance of winning each. The pieces are randomized in the pack and dispensed or distributed to customers at a particular location. Pieces sold at one location cannot be redeemed at another location.

In-Pack Chance Promotions are promotional games, wherein a player receives a playing card or playing ticket (game piece) that gives the player an opportunity to win an instant prize. The In-Pack Chance Promotion differs from a lottery by the game piece itself having a value component, either through a coupon on the game piece for other goods or through inherently having value such as being a collectible item. The instant win portion of the game serves as a promotional incentive to encourage purchasing or obtaining the game pieces. Another differentiating component is that it is not necessary to purchase a game piece, as participants have the ability to obtain free game pieces, notably by writing in to the promoter and requesting game pieces. Finally, the In-Pack Chance Promotion has a defined end-date, clearly states the odds of winning, and generally promoters are required to keep track of personal information of winners of prizes exceeding a certain value.

In the past, tickets were both sold to the customers and prizes paid out by staff on location. However, this method is very inefficient and prone to fraud and theft. A primitive solution to address some of these concerns was an automatic dispensing machine to make the process of selling gaming pieces more efficient and to keep better inventory of gaming tickets. A further innovation was the implementation of the ability to scan location-specific game pieces on an automatic payout station via a unique computer readable code hidden with the prize combinations on each piece.

However, the machines to accurately and speedily receive payment and dispense the purchased tickets have significant costs, and the initial purchase of a dispenser places a capital burden on the promoter wishing to offer the game pieces to its customers. In some cases, the vending machine acquisition costs can be prohibitively costly for many operators. This challenge is faced by manufacturers of consumer products in other fields as well.

What is needed is an arrangement by which manufacturers of retail products such as in-pack game promotions can assist promoters with the capital cost of a dispenser, while recovering the cost over time by limiting the dispenser to only licensed products.

### SUMMARY OF THE INVENTION

The vending machine of the present invention is configured to allow a manufacturer to provide it to a retailer without upfront cost, allowing the manufacturer to recover its costs by a per unit dispensed charge. The vending machine may be used for in-pack chance promotion game pieces or other items and has a housing with a compartment for retaining items to be sold. A controller is mounted to the housing and is connected to a remote computer operated by a manufacturer, supplier or owner of the vending machine. The remote computer maintains data indicating the number of items which the dispenser has been licensed to dispense. The controller controls an actuator to selectively release items to purchasers who provide payment through a payment interface. When payment is received, the controller determines if the dispenser is licensed to dispense the number requested, and if so, operates the controller to dispense the items, if the dispenser is not licensed to dispense the full amount, the actuator dispenses items up to the licensed number and refunds to the purchaser any payment made beyond that due for the dispensed items.

A vending machine is also provided for any consumer item, such as canned beverages, which requires the operator of the vending machine to receive advance approval for dispensing from the machine, which can be provided by a preprinted machine-readable code affixed to the bulk container of beverage cans or other vendable items.

It is an object of the present invention to provide a dispenser of in-pack chance promotion game pieces which can be limited to dispensing game pieces of a particular manufacturer.

It is another object of the present invention to provide a dispenser of items which determines whether it has been licensed to dispense an item before dispensing.

It is a further object of the invention to provide a vending machine for consumer products which dispenses only items for which the dispensing approval has been received in advance.

Further objects, features and advantages of the invention will be apparent from the following detailed description when taken in conjunction with the accompanying drawings.

### BRIEF DESCRIPTION OF THE DRAWINGS

FIG. 1 is an isometric view of a carton of in-pack chance promotion game pieces marked with a machine-readable code authorizing dispensing by an automated vending machine.

FIG. 2 is a schematic isometric view of an in-pack chance promotion vending machine of this invention.

FIG. 3 is an isometric view of a carton of canned beverages marked with a machine-readable code authorizing dispensing by an automated vending machine.

FIG. 4 is a schematic isometric view of a beverage vending machine configured to dispense only authorized products.

### DESCRIPTION OF THE PREFERRED EMBODIMENTS

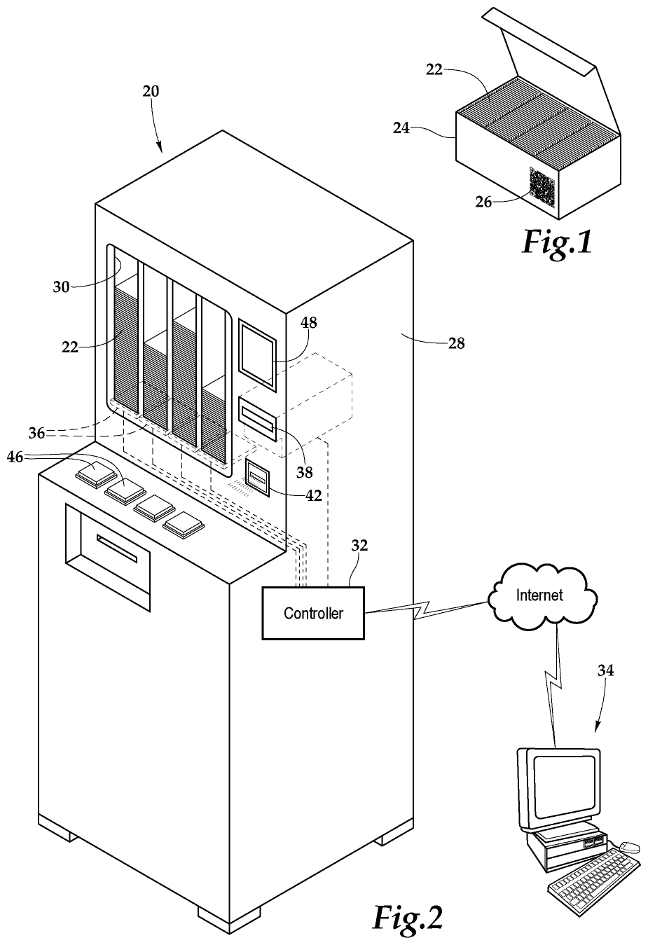

Referring more particularly to FIGS. 1-4, wherein like numbers refer to similar parts, a vending machine 20 or game piece dispenser of this invention is shown in FIG. 2. The vending machine 20 is configured to dispense in-pack chance promotion game pieces 22, which are provided by the manufacturer to the promoter in cartons or packs 24 containing multiple pieces as shown in FIG. 1. Although game pieces 22 or tickets can be sold to customers directly by staff, the convenience of an automated dispenser is appreciated by customers and the automated machines relieve a burden on bar and restaurant staff who are occupied with serving meals and drinks. However, the machines to accurately and speedily receive payment and dispense the purchased tickets have significant costs, and the initial purchase of a dispenser places a capital burden on the promoter wishing to offer the game pieces to its customers.

To reduce the initial investment by the promoter, the manufacturer of game pieces may offer a dispensing machine at a reduced price, allowing the manufacturer to recover its costs over time through the sales of its products dispensed from the machine. The manufacturer offers the promoter a version of the pull-tab dispensing machine 20 which has a limited dispense count. In other words, the machine 20 is configured to only dispense product up to the number pre-authorized by the manufacturer. The authorized dispense count is increased by entering a unique code provided by the manufacturer, for example by being printed as a QR machine-readable code 26 on the game piece carton 24, as shown in FIG. 1, or purchased through the supplier and delivered in various ways such as on a USB stick, a flash card, via email, remote activation, etc. The vending machine 20 may thus be provided with additional vending authorizations through multiple modes in addition to scanning a printed code. For example, the vending machine may be provided with a keypad through which the promoter may enter a code for additional vending authorizations. An online sales portal may be configured to sell additional vending authorizations, either communicating directly with the vending machine controller, or by emailing a printed code or a number for keypad entry. The manufacturer may make additional dispenses available through promotional methods, such as in connection with the sales of other products, i.e., free dispenses are offered beyond those attached to the purchase of the vended products. By purchasing additional vending authorization, the promoter may use generic product issued by manufacturers other than the owner of the vending machine. Thus the promoter can reactive a machine that has exceeded its dispense authorization, by purchasing additional dispense authorization separately from vendable product.

As shown in FIG. 2, the vending machine 20 for in-pack chance promotion game pieces has a housing 28 with a compartment 30 for retaining in-pack chance promotion game pieces or pull-tabs. Product selection buttons 36 are mounted to the housing to allow a purchaser to select which items are desired to be purchased. A controller 32 is mounted to the housing 28 and is connected to a remote computer 34 operated by a supplier of game pieces and dispensers. The connection may be over the internet. The remote computer 34 maintains data indicating the number of game pieces which the dispenser 20 has been licensed to dispense and this number may be stored on the controller as well. The controller 32 controls actuators 36 to selectively release game pieces to purchasers who provide payment through a payment interface 38 which may include a bill acceptor and a credit card reader. When payment is received, the controller 32 determines if the dispenser is licensed to dispense the number requested, and if so, operates the actuators 36 to dispense the game pieces. If the dispenser 20 is not licensed to dispense the full amount requested by the customer, the actuators 36 are activated to dispense game pieces up to the licensed number and the purchaser is refunded any payment made beyond that due for the dispensed elements. Alternatively, when payment is received, the controller 32 may query the remote computer 34 and, if it determines the dispenser is licensed to dispense the number requested, operate the actuators 36 to dispense the game pieces.

The promoter may load the dispense authorization to a particular vending machine 20 by displaying the QR code 26 on the product carton 24 to an optical scanner 42 on the face of the machine which is connected to the controller 32. The machine then accesses the internet to confirm with the database on the remote computer 34 that the dispense authorization is valid, and has not been used elsewhere. The controller 32 then is enabled to dispense the number of elements as instructed by the remote computer and the dispense code is flagged as consumed in the remote database. Thereafter, the carton, if scanned, will not result in additional dispense authorizations.

The controller may be provided with a software counter which increments with each dispense, with the counter determining the products dispensed up to the authorized limit; or the counter could decrement with each dispense to indicate the number of remaining dispenses until the number is zero. This value or “authorized number” corresponds to the number of items which are authorized to be dispensed on the vending machine by the manufacturer. When the counter indicates no remaining authorized dispenses, i.e., when the threshold of permitted dispenses is reached, the controller causes the machine 20 to cease to operate or limits its function. When the controller 32 determines that the licensed number of dispenses has been reached, in addition to ceasing to operate the actuators 36, the controller 32 may also render the machine's credit-card reader or bill acceptor payment interface 38 inactive. Alternatively, the product selection buttons 46 could be deactivated, and an “out of order” message may be displayed to a prospective purchaser on a display screen 48 on the front of the dispenser 20.

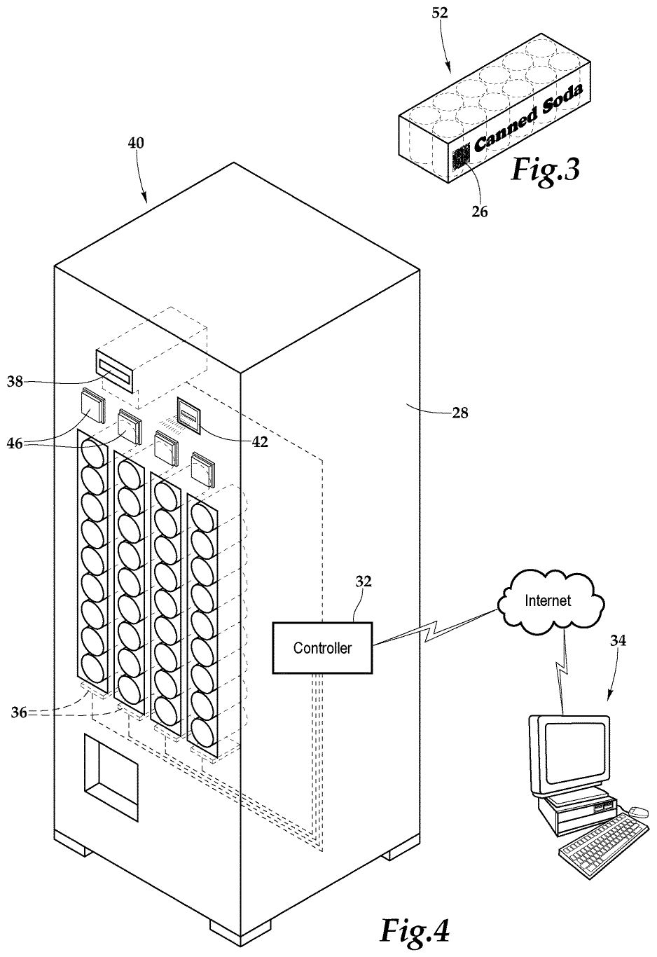

The dispenser of this invention may be used in many industries where a company makes both a dispensing machine and provides the vendable product to distributors. For example, a concern in the soda industry is brand damage to a company due to imitation or inferior products being sold out of a machine that is branded for that company. As shown in FIGS. 3 and 4, a beverage vending machine 40 may be provided by a soda company. The soda company may include a machine-readable code such as a QR code 26 on the outside of twelve-packs of soda 52 that adds twelve dispense credits to a soda vending machine. A soda company can then offer an advantageously priced and steeply discounted dispensing machine, taking into account the financial benefit of the company's own product being purchased over time for dispensing with the machine, or receiving fees for the purchase of dispense credits to dispense other manufacturer's beverages.

The dispenser 20, 40 may also provide advance signals to the promoter that the number of dispenses remaining has reached a reduced level which is less than the original amount authorized but greater than zero, offering the promoter an opportunity to purchase additional dispense credits, before the current levels are exhausted. For example, the advance signal may be an email notification.

It should be noted that a single promoter may have multiple dispensers at his site, only some of which are limited. The promoter may purchase additional dispense credits beyond those which come with a pack of game pieces from the manufacturer of the limited dispenser. In this way, the promoter may use the limited dispenser to dispense products from a variety of manufacturers.

Alternatively, where the dispenser is not connected to a remote computer, dispensing authorization may be provided on a USB storage device wherein the USB storage device contains software that, once the authorization code has been accepted by the dispenser, the USB storage device is flagged as no longer operable.

Where an operator has multiple dispensers or a business has multiple servers, even at multiple locations, the dispensers may all be connected to the same remote computer which tracks authorized dispenses for a group of dispensers. Thus the operator or business may purchase dispense authorizations for all the dispensers in use, for example through the online portal, and the remote computer tracks each dispense on all the dispensers, allowing items to be dispensed so long as the authorized number is greater than zero, regardless of which dispenser is operated. When the authorized number reaches zero, than all the group of dispensers will no longer be able to dispense. In this arrangement, it is not required for individual operators to scan authorization codes for each dispenser.

It is understood that the invention is not limited to the particular construction and arrangement of parts herein illustrated and described, but embraces all such modified forms thereof as come within the scope of the following claims.

I claim:

1. A dispenser of items for sale to a purchaser, comprising:
a housing having a compartment for retaining a plurality of items;
a controller mounted to the housing and provided with an authorized number indicating the number of items which the dispenser has been licensed to dispense; and
an actuator mounted to the housing for selective release of one or more of the items in response to a purchase, wherein the actuator is connected to the controller; and
a purchase interface mounted to the housing through which a purchaser provides payment and selects a desired quantity of items to purchase, the purchase interface connected to the controller, wherein the controller maintains a counter which subtracts from the authorized number for each item purchased and released from the housing compartment, wherein the controller operates the actuator to dispense items up to the authorized number, and to determine whether the total number of items requested by the purchaser are less than the authorized number, and, if so, to instruct the actuator to dispense the requested items to the purchaser and, if the total number of items requested to be purchased is greater than the authorized number, to dispense items to the purchaser up to the number of items licensed and to refund to the purchaser any payment made beyond that due for the dispensed items.

2. The apparatus of claim 1 wherein the apparatus is configured to send a notification to a designated operator when the authorized number maintained by the counter reaches a level which is less than an original authorized number but greater than zero to give the operator an opportunity to increase the authorized number.

3. The apparatus of claim 1 wherein the controller operates when the counter reaches zero to render the apparatus's purchase interface inactive.

4. The apparatus of claim 1 wherein the controller operates when the counter reaches zero to display an “out of order” message to a prospective purchaser on a display screen mounted to the housing.

5. The apparatus of claim 1 further comprising a removable USB storage device wherein the authorized storage number is provided by the USB storage device, the USB storage device containing software that, once an authorization code has been accepted by the controller, the USB storage device is flagged as no longer operable.

6. The apparatus of claim 1 further comprising a second like apparatus, and both are connected to a remote computer, wherein the remote computer supplies the authorized storage number to both apparatus.

7. A vending machine for dispensing items for sale to a purchaser, comprising:
a housing having a compartment for retaining a plurality of items;
a controller mounted to the housing and connected in data-receiving relationship to a remote computer, wherein the controller is configured to retain an authorized number, corresponding to the amount of items authorized to be dispensed from the compartment, and to reduce the authorized number each time an item is dispensed; and
an actuator mounted to the housing for selective release of one or more of the items in response to a purchase, wherein the actuator is connected to the controller; and
a purchase interface mounted to the housing through which a purchaser inserts payment and selects a desired quantity of items to purchase, the purchase interface connected to the controller, wherein the controller is configured to activate the actuator to dispense one of the plurality of items only so long as the authorized number is greater than zero; and
wherein the controller is connected to receive authorizing input from exterior to the vending machine which increases the authorized number, and to query a remote computer prior to increasing the authorized number to confirm that authorizing input is deemed valid by the remote computer.

8. The vending machine of claim 7 further comprising a scanner mounted to the housing, and wherein the controller is connected to the scanner to scan a printed authorizing input.

9. The vending machine of claim 7 wherein the controller is connected to the remote computer via the internet and is configured to receive authorizing input from the remote computer in response to an electronic payment.

10. The vending machine of claim 8 wherein the printed authorizing input is a machine readable code which corresponds to a code which is maintained on a database of authorized dispense codes on the remote computer.

11. The vending machine of claim 7 further comprising a keypad for the input of an authorizing code, allowing the controller to receive the authorizing input from exterior to the vending machine.

12. A method for dispensing items for sale to a purchaser from a vending machine having a housing, a compartment for retaining the items, an actuator for releasing items from the compartment for dispensing to the purchaser, a controller which controls the actuator and communicates with an input device and a remote computer, the method comprising:
retaining in the controller an authorized number corresponding to the number of items authorized to be dispensed from the compartment, wherein the authorized number is input from exterior to the vending machine through the input device;
checking the input authorized number on the remote computer to confirm that the authorized number is approved by the remote computer;
reducing the authorized number each time the actuator is activated to dispense an item; and
dispensing an item from the vending machine so long as the authorized number is greater than zero and declining to dispense items from the vending machine when the authorized number is zero.

13. The method of claim 12 wherein the vending machine further comprises a purchase interface mounted to the housing through which a purchaser inserts payment and selects a desired quantity of items to purchase, the purchase interface connected to the controller, and further comprising: rejecting payments input at the purchase interface when the authorized number is zero.

14. The method of claim 12 wherein the input device is a scanner and further comprising the step of inputting the authorized number from exterior to the vending machine by scanning a machine readable code.

15. The method of claim 14 wherein the step of inputting the authorized number by scanning a machine readable codes comprises scanning a container of the items to be dispensed from the vending machine.

16. The method of claim 12 wherein the input device is an internet connection and the step of inputting the authorized number comprises downloading authorization from an online store.

17. The method of claim 12 wherein the input device is a keypad and the step of inputting the authorized number comprises using the keypad.
